(19) United States
(12) Patent Application Publication
(10) Pub. No.: US 2002/0106256 A1
(43) Pub. Date: Aug. 8, 2002

(54) Expandable anchorage

(76) Inventors: Werner Kaibach, Buchloe (DE); Stefan Raber, Kaufering (DE); Andreas Eckstein, Landsberg am Lech (DE)

Correspondence Address: DAVID TOREN, ESQ., SIDLEY, AUSTIN, BROWN & WOOD, LLP, 875 THIRD AVE, NEW YORK, NY, 10022, US

(21) Appl. No.: 10/072,720

(22) Filed: Feb. 6, 2002

(30) Foreign Application Priority Data
Feb. 7, 2001 (DE) 10105407.6

(51) Int. Cl. F16B 13/06

(52) U.S. Cl. 411/60.1

(57) ABSTRACT

A fastening means is formed of an axially extending shank (1) and an expansion sleeve (3) that is expanded by an expansion cone (2) serving to anchor a member to a structural part. The shank (1) has on its leading end section in the setting direction a cross-sectionally reduced or reduced diameter section (4) to which the expansion cone (2) expanding in the setting direction is connected. The wall thickness (W) of the expansion sleeve (3) corresponds to 0.25 to 0.5 times the external diameter of the reduced diameter section (4). By using the solid construction of the expansion sleeve (3) high load capacities are gained in particular with loading of the anchorage opposite the setting direction (S).

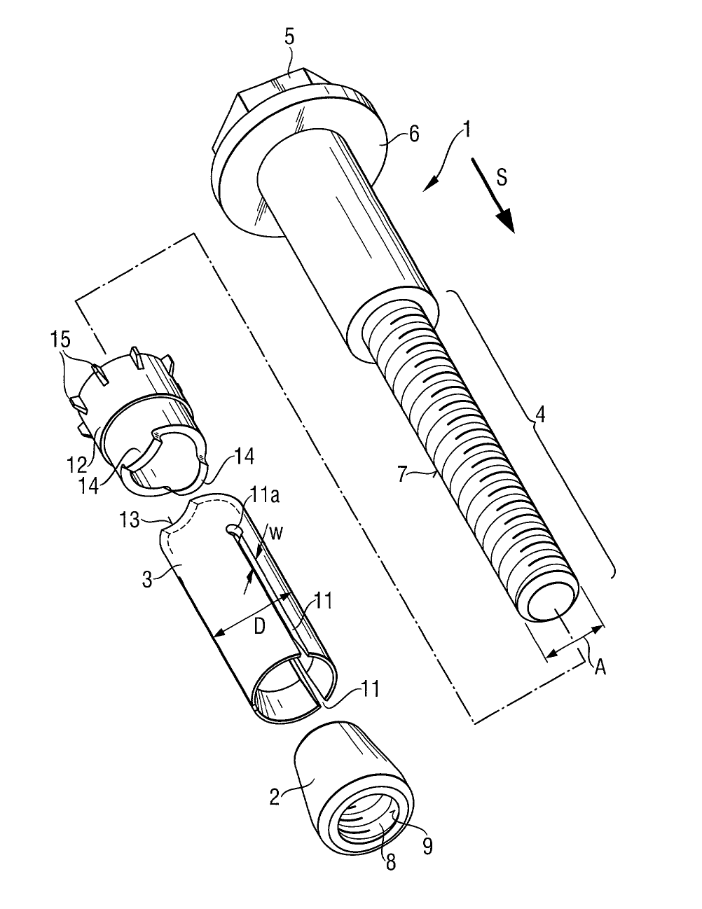

### FIELD OF THE INVENTION

The invention relates to a fastening means for anchoring a member in a bore hole, comprised of a shank that has on its trailing end a means for fastening the member and extending from its leading end at least one section that is reduced in cross-section and has an expansion cone mounted on the leading end of the section, whereby the reduced section is surrounded at least in part by a sleeve that is expandable by the action of the expansion cone with the sleeve having a plurality of open longitudinal slots extending in the setting direction.

### BACKGROUND OF THE INVENTION

Fastening means of this type are particularly suitable for use in hard building materials. A shank exhibits a threaded shank portion penetrating through a structural component and an object to be fastened, the threaded shank having means for fastening the object. The means used for fastening can, for example, include a nut that by turning on the threaded shank draws an expansion cone arranged on the shank into an expansion sleeve abutting the wall of the bore hole. In this process, the expansion sleeve expands and wedges itself in the bore hole. The contact of the expansion sleeve in the bore hole is achieved, for example, by means of locking elements formed on the sleeve that drive into the bore hole wall.

DE-A1-19716926 discloses such a fastening means having an expansion cone over which an expansion sleeve is arranged. The expansion sleeve has in the setting direction a plurality of open longitudinal slots and is, for example, manufactured from sheet metal strips using a die cutting technique.

This known fastening means permits exceptionally economical manufacture but does not allow high loads, in particular in the case of loads that stress in the direction opposite to the setting direction.

### SUMMARY OF THE INVENTION

The primary object of the present invention is to provide a fastening means for anchorage in a bore hole that can be used also for heavy loads, in particular for loads stressing in the direction opposite the setting direction.

According to the invention, the object is achieved in that the wall thickness of the expansion sleeve is 0.25 to 0.5 times the outside diameter of the cross-sectionally reduced axially extending section of the fastening means shank.

Due to the fact that the wall thickness is strongly fashioned in relation to the outside diameter of the cross-sectionally reduced section, pulling of the shank with the expanding cone through the expansion sleeve and consequent failure of the fastening is prevented. On the other hand, at high loads there is a compression of the expansion sleeve into the wall of the bore hole. This advantage takes effect particularly with high loads which stress the fastening means in the direction opposite the setting direction.

In a particularly advantageous embodiment the diameter of the outside surface of the expansion sleeve corresponds to 1.25 to 1.6 times the outside diameter of the cross-sectionally reduced section in order to achieve optimum load levels of the fastening means in the structural part.

Preferably, the expansion cone is connected to the reduced section by threading in order to assure economical manufacture.

Advantageously at least one part of the means for fastening an object is connected to the rest of the shank. The fastening means is, for example, a hexagonal head or a polygonal recess on the trailing end facing away from the setting direction and provided with a washer. Thus, the setting process is at once made manageable while the fastening means can be economically produced.

### BRIEF DESCRIPTION OF THE DRAWING

The invention is explained more completely in the following read together with an exemplary embodiment. The drawing is an exploded axially extending view of a fastening means embodying to the invention.

### DETAILED DESCRIPTION OF THE INVENTION

The drawing illustrates a fastening means according to the invention comprised of a axially extending shank 1 and an axially extending expansion sleeve 13 that can be expanded radially outwardly by an expansion cone 2. The shank 1 has on its trailing end opposite the setting or leading end a means for fastening a member which, for example, can be executed as a hexagonal head 5 and a washer 6. At the opposite end, the shank 1 has an axially extending reduced cross-sectional or reducing diameter section 4 with at least one expansion cone 2 that is connected thereto and widens in the setting direction S. The section 4 is provided with an external male thread 7 which can be screw connected by means of an internal female thread arranged in a passage hole 8 of the expansion cone 2.

The expansion sleeve exhibits three open ended equiangularly distributed longitudinal slots 11 open in the radial direction and running in the setting direction S. At the trailing end in the setting direction 5 of the longitudinal slots 11 the expansion sleeve has a through hole 11a.

On the setting direction trailing end of the expansion sleeve 3 partially enveloping the reduced diameter section 4, a connector element 12 partially encompasses the reduced section at its end facing away from the setting direction. The expansion sleeve 3 exhibits on the end facing away from the setting direction a circular recess 13 into which a complementary web 14 arranged on the connector element 12 can be applied. The connector element 12 exhibits circumferentially extending evenly distributed and radially outwardly extending claws 15 that provide for the rotational resistance of the connector element 12, in particular for the expansion sleeve 3.

The wall thickness w of the expansion sleeve 3 corresponds to 0.4 times the outside diameter A of the reduced diameter section 4. Furthermore, the diameter D of the outside surface of the expansion sleeve 3 corresponds to 1.3 times the outside diameter A of the cross-sectionally reduced section 4.

What is claimed is:

1. A fastening means for anchoring a member in a bore hole comprises an axially extending shank (1) having a setting direction (S) into the bore hole with a trailing end and a leading end and with attachment means (5, 6) at the trailing end for securing the member in the bore hole with at least one axially extending reduced diameter section (4) housing an outside diameter (A) and extending from the leading end towards and spaced from the trailing end, at least one expansion cone (2) connection to the leading end of said shank (1), said expansion cone (2) having an outside surface angled outwardly in the setting direction (S), said reduced diameter section (4) is enclosed within at least one axially extending expansion sleeve (1) trailing said cone (2) in the setting direction and arranged to be expanded by said cone (2), said expansion sleeve (3) having a plurality of open ended axially extending slots extending from a leading end of said sleeve, and said expansion sleeve (3) having a wall thickness (W) in the range of 0.25 to 0.5 times the outside diameter (A) of said section (4).

2. A fastening means, as set forth in claim 1, said expansion sleeve (3) having an outside diameter (D) in the range of 1.25 to 1.6 times the outside diameter (A) of said reduced diameter section (4).

3. A fastening means, as set forth in claim 1, wherein said expansion cone (2) has an inside thread (8) in threaded engagement with a thread (7) on said reduced diameter section (4).

4. A fastening means, as set forth in claim 1, wherein at least one part of said attachment means (5, 6) is connected to said shank (1).
